(19) United States
(12) Patent Application Publication
(10) Pub. No.: US 2008/0096673 A1
(43) Pub. Date: Apr. 24, 2008

(54) Adapter for auxiliary LCD gaming console

(75) Inventor: Robert R. Lube, Countryside, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wells Garder Electronics Corporation, McCook, IL (US)

(21) Appl. No.: 11/897,261

(22) Filed: Aug. 28, 2007

Related U.S. Application Data
(60) Provisional application No. 60/840,530, filed on Aug. 28, 2006.

(51) Int. Cl. G06F 17/00

(52) U.S. Cl. 463/47

(57) ABSTRACT

Adapters and support members for auxiliary video display systems in gaming units are disclosed. Methods of supporting auxiliary video display systems are also disclosed.

### CROSS-REFERENCES TO RELATED APPLICATIONS

This application claims priority to and benefit under 35 U.S.C. § 119(e) to U.S. provisional application Ser. No. 60/840,530, filed Aug. 28, 2006.

### FIELD OF THE INVENTION

The subject invention relates to consoles that house video displays. More particularly, the invention relates to a device for adapting auxiliary video displays designed for mounting onto CRT displays to mount onto flat-panel video displays.

### BACKGROUND OF THE INVENTION

A wide variety of video consoles exist that are designed to house or mount one or more video displays and further house and protect the electronics associated with the video display. In a casino environment, for example, wager-based video games are provided in several different basic configurations, including the upright gaming consoles that house electronics and one or more video displays and which is portable, and the bar-top gaming console that is installed within a bar and is configured to present a wager-based game to a user seated at the bar. The wager-based video game units may be configured to display any number of wager-based video games, including video poker, video slots, and keno, to name but a few.

FIG. 1 illustrates a conventional bar-top gaming unit 10. The bar-top gaming unit 10 includes a plate 14 to which the user-interactive features are primarily mounted. The plate 14 is mounted on the bar surface or top 12, and is mounted over a housing (not shown) within the bar. A CRT video display 20 is mounted and supported within the housing, or is attached to the underside of the plate 14. A bezel 22 surrounds and supports the periphery of the CRT display 20, and provides a seal over the CRT 20 to prevent debris and liquids from migrating into the housing. The surface of most CRT displays 20 used in bar-top units 10 have a convex curvature, and thus are not flat. The bezel 22 may further position the CRT display 20 at a slight angle towards the user to facilitate viewing of the video display 20. The bar-top gaming unit 10 ordinarily includes most or all of the peripheral items common to upright consoles. Such peripheral items may include buttons 16, a coin hopper 18, lights (not shown), and bill validator 24.

Traditionally, video gaming units 10 paid out winnings in the form of coins dispensed into a coin hopper 18. As shown in FIG. 2, video gaming units 110 such as that shown and described with respect to FIG. 1 are now increasingly being modified to pay out winnings in the form of credits to a computer-readable card. The user may redeem winnings at the casino cashier or at a centralized automated kiosk. As shown in FIG. 2, in such modified gaming units 110, the coin hopper may be covered over with a plate 118 or the like, and a card validator 126 is operatively connected to the electronic controller (not shown) within the housing. During use, a user inserts a computer-readable card into the card-validator 126 to initiate the game. The gaming controller or other electronics determines whether gaming credits have been purchased for the card, and the amount. This payment system is often generically referred to as a card in/card out system.

Information regarding the available credits may be displayed on auxiliary video display 128. Auxiliary video display unit 130 may be mounted at the rear of the bezel 122, and at an angle appropriate for display to a user seated at the bar 112 in front of the gaming unit 110. Auxiliary video display unit 128 may be mounted within housing 132 and visible through opening 133. Housing 132 may also include a front, sides, a top surface, and a rear panel (not shown). A card validator 126 may be operatively connected to the bar-top gaming console 110 through housing 132 by way of wires (not shown) threaded through a conduit 134 attached to a side of the housing 132. In this configuration, card validator 126 is mounted onto plate 114, flush with the surface. Video display 128 within unit 130 may be a flat panel video display, such as an LCD display. Auxiliary video display units may be retrofitted onto CRT-type bar-top gaming units, which obviates the need for a casino to replace an entire bar-top gaming unit 110 in order to implement a card in/card out system in existing gaming consoles 110. Player tracking systems for retrofitting bar-top gaming units having CRT displays are available from the Acres Gaming Division of IGT Corp. of Reno, Nev.

Wager-based games having video displays are increasingly being designed to include flat panel displays, such as LCDs and the like, to display the game, to the exclusion of CRT displays. Flat panel displays have numerous benefits over CRT displays in gaming units, including, for example, higher quality picture quality, smaller profile, and less power consumption.

A CRT display may be replaced by a flat panel display in a gaming unit without replacing the entire gaming unit. As shown in FIG. 3, a bar-top gaming unit 210 having a flat panel display 220 (preferably an LCD display) may include the same peripheral items as a traditional CRT. Mainly because an LCD-type flat panel display 220 requires a viewing angle of between 0 and 90 degrees depending on the specific display used, the display 220 may be positioned by a novel bezel 222 at a steeper angle than would a CRT display, and at a level above the bar top 212. As such, a bar-top console 210 having an LCD display 220 mounted therein may include a novel bezel 222 configured to hold the flat panel display 220 at the desired angle.

A bar-top gaming unit 210 having been retrofitted with a card in/card out system mounted over the CRT system generally works well to allow a casino to provide a cashless gaming unit, but such a system is not without limitations. In the event that it becomes desirable or necessary to replace the CRT display within the bar-top gaming unit shown in FIG. 3, for example, the card in/card out system cannot be mounted on a novel bezel 222 for a flat panel display 220 and remain in an optimal position, nor will the card validator be supported from below. This is due to the rear of the novel flat panel display bezel 222 having a greater height relative to the plate 214 than the CRT bezel. In addition, auxiliary video display housing 130, such as that shown in FIG. 2, has a concave bottom side 129 in order to mount over the convex surface of the CRT bezel 122. As such, to the extent the auxiliary video display housing 130 could be placed onto the novel flat panel display bezel 222, the housing 130 would not lie flat along the top border 231 of the novel bezel 222. Another problem associated with an attempt to mount the auxiliary video display housing 132 over the novel flat panel display bezel 222 is that the distance between the outer and inner edge at the top region of a CRT bezel 122 may be relatively long when compared to a flat panel display bezel, and thus the bottom surface of the auxiliary video display unit 130 that is configured to contact the top surface of the CRT bezel 122 is generally relatively deep. Thus, to the extent auxiliary video display unit 130 is placed onto novel flat panel display bezel 222, auxiliary video display unit 130 would overlap and partially obscure the top region of flat panel display 220. Yet another problem posed by an attempt to fit a the auxiliary video display housing 132 onto novel flat panel display bezel 222 is that, due to the increased height of the bezel rear side 235 as compared to a CRT bezel 122, the card validator 126 that may be attached to the auxiliary video display housing 132 would project outwardly from the auxiliary video display housing 132, and into space. Such lack of support exposes the card validator 126 and associated wiring to the possibility of a sheering force from the top, sides or bottom. There is a need, therefore, for a system to implement an auxiliary video display housing and card validator designed to mount over a CRT display onto a gaming unit having a flat panel display. The present invention fulfills these needs.

### BRIEF SUMMARY OF THE INVENTION

Embodiments of the invention include a gaming console configured for presenting a plurality of video displays to a user. The gaming console includes a bezel, the bezel being adapted to position and mount a flat panel video display, the bezel having a generally annular top surface with peripheral edges, the generally annular top surface having a rear portion, the bezel further including at least two sides and a back attached to peripheral edges of the bezel top surface. A support member is attached to the rear portion of the bezel top side, the support member having a top surface being adapted to engage an auxiliary video display, the support member further including a bottom surface adapted to engage at least one of the rear portion of the bezel top side and the bezel back. The gaming console may further comprise an auxiliary video display mounted to the support member top side.

In other embodiments, wherein the auxiliary video display has a concave bottom surface adapted to mount over a convex surface, and wherein the auxiliary video display bottom surface and the support member top surface define a gap therebetween when the auxiliary video display is mounted on the support member top surface, and wherein the support member top surface has a front edge, the gaming console may further comprise a cover attached proximate the front edge of the support member top surface, the cover being adapted to extend over the gap between the auxiliary video display bottom surface and the support member top surface.

In certain embodiments, wherein the gaming console is a bar-top or table-top console having a substantially horizontal mounting surface to which peripheral electronics and video displays may be mounted, and wherein the auxiliary video display has a housing and the auxiliary video display is elevated relative to the mounting surface, the gaming console may further comprise a card reader assembly attached to the auxiliary video display housing, the card reader extending laterally from the auxiliary video display housing, the card reader assembly including a bottom side, the card reader bottom side positioned at an elevation above the mounting surface; and a support positioned below at least a portion of the card reader bottom side, the support extending between the at least a portion of the card reader bottom side and the mounting surface. In other embodiments, wherein the gaming console is a bar-top or table-top console having a substantially horizontal mounting surface to which peripheral electronics and video displays may be mounted, the gaming console may further comprise peripheral electronics mounted to the mounting surface, wherein the peripheral electronics are configured to allow user interaction with a game implemented by the gaming console. In still other embodiments, the gaming console may further comprise a flat panel video display disposed within the bezel; and a touch screen device operatively associated with the flat panel video display, wherein the touch screen device is configured to allow user interaction with a game implemented by the gaming console.

Other embodiments of the invention include a support member for mounting an auxiliary video display. The support member comprises a top surface adapted to engage and support a bottom surface of an auxiliary video display; and a bottom surface adapted to engage at least one of a top surface and a back surface of a bezel. In some embodiments, wherein the support member top surface is adapted to engage an auxiliary video display having a concave bottom surface, and wherein the support member has a front edge, the support member may also include a cover attached proximate the front edge of the support member top surface, the cover being adapted to extend over a gap between a concave auxiliary video display bottom surface and the support member top surface when an auxiliary video display having a concave bottom surface is mounted thereon. In other embodiments, the support member bottom surface may be adapted to engage a bezel for mounting a flat panel display. In still other embodiments, the support member bottom surface is adapted to engage at least one of a top surface and a back surface of a bezel for mounting a flat panel display.

Methods of presenting a plurality of video displays to a user are also disclosed. In one embodiment, the method includes providing a bezel, the bezel being adapted to position and mount a flat panel video display, the bezel having a generally annular top surface with peripheral edges, the generally annular top surface having a rear portion, the bezel further including at least two sides and a back attached to peripheral edges of the bezel top surface; and attaching a support member to the rear portion of the bezel top side, the support member having a top surface being adapted to engage an auxiliary video display configured to mount over a CRT display bezel, the support member further including a bottom surface adapted to engage at least one of the rear portion of the bezel top side and the bezel back.

In certain embodiments, the method may include providing an auxiliary video display; and mounting the auxiliary video display to the support member top side. In other embodiments, wherein the auxiliary video display has a concave bottom surface adapted to mount over a convex surface, and wherein the auxiliary video display bottom surface and the support member top surface define a gap therebetween when the auxiliary video display is mounted on the support member top surface, and wherein the support member top surface has a front edge, the method may include attaching a cover proximate the front edge of the support member top surface, the cover being adapted to extend over the gap between the auxiliary video display bottom surface and the support member top surface.

In other embodiments, wherein the gaming console is a bar-top or table-top console having a substantially horizontal mounting surface to which peripheral electronics and video displays may be mounted, and wherein the auxiliary video display has a housing and the auxiliary video display is elevated relative to the mounting surface, the method may include providing a card reader assembly attached to the auxiliary video display housing, the card reader extending laterally from the auxiliary video display housing, the card reader assembly including a bottom side, the card reader bottom side positioned at an elevation above the mounting surface; providing a support positioned below at least a portion of the card reader bottom side, the support extending between the at least a portion of the card reader bottom side and the mounting surface; and supporting the card reader assembly with the support.

In other embodiments of the method, wherein the gaming console is a bar-top or table-top console having a substantially horizontal mounting surface to which peripheral electronics and video displays may be mounted, the method may further include mounting peripheral electronics to the mounting surface, wherein the peripheral electronics are configured to allow user interaction with a game implemented by the gaming console. The method may also or alternately include disposing a flat panel video display within the bezel; and providing a touch screen device operatively associated with the flat panel video display, wherein the touch screen device is configured to allow user interaction with a game implemented by the gaming console.

### BRIEF DESCRIPTION OF THE DRAWINGS

FIG. 1 illustrates a perspective view of a bar-top gaming unit with CRT display according to the prior art;

FIG. 2 illustrates a perspective view of a bar-top gaming unit with CRT display and auxiliary video display according to the prior art;

FIG. 3 illustrates a perspective view of a bar-top gaming unit with flat panel display;

FIG. 4A illustrates a perspective view of a bar-top gaming unit with flat panel display, auxiliary video display, adapter and spacer according to an embodiment of the invention;

FIG. 4B illustrates an exploded view of the bar-top gaming unit with flat panel display, auxiliary video display, adapter and spacer depicted in FIG. 4A;

FIG. 5 illustrates a perspective view of an adapter according to an embodiment of the invention;

FIG. 6 illustrates a rear view of an adapter according to an embodiment of the invention;

FIG. 7 illustrates a side view of an adapter according to an embodiment of the invention; and

FIG. 8 illustrates a support and card validator according to an embodiment of the invention.

### DETAILED DESCRIPTION OF THE INVENTION

While the present invention, in one embodiment, is particularly well suited for use with bar-top gaming consoles or assemblies as described herein, the system may be used with a variety of other video consoles, such as flat-top gaming consoles.

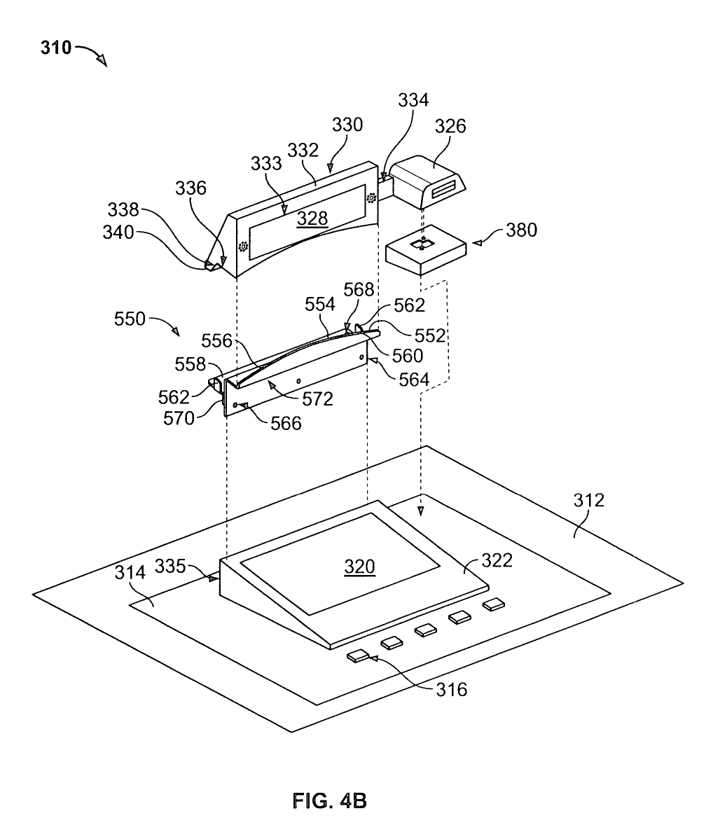

FIG. 4 illustrates one embodiment of the invention as implemented in a bar-top gaming unit 310 having an auxiliary video display unit 330 associated with it. Bar-top gaming unit 310 includes a flat panel display 320, such as an LCD display, and a bezel 322 for mounting and positioning the display 320 mounted to plate 314. Peripheral buttons 316 may be further mounted to plate 314 for interacting with a game implemented on display 320. Alternately, display 320 may include a touch panel for allowing a user to make selections, by touching display 320.

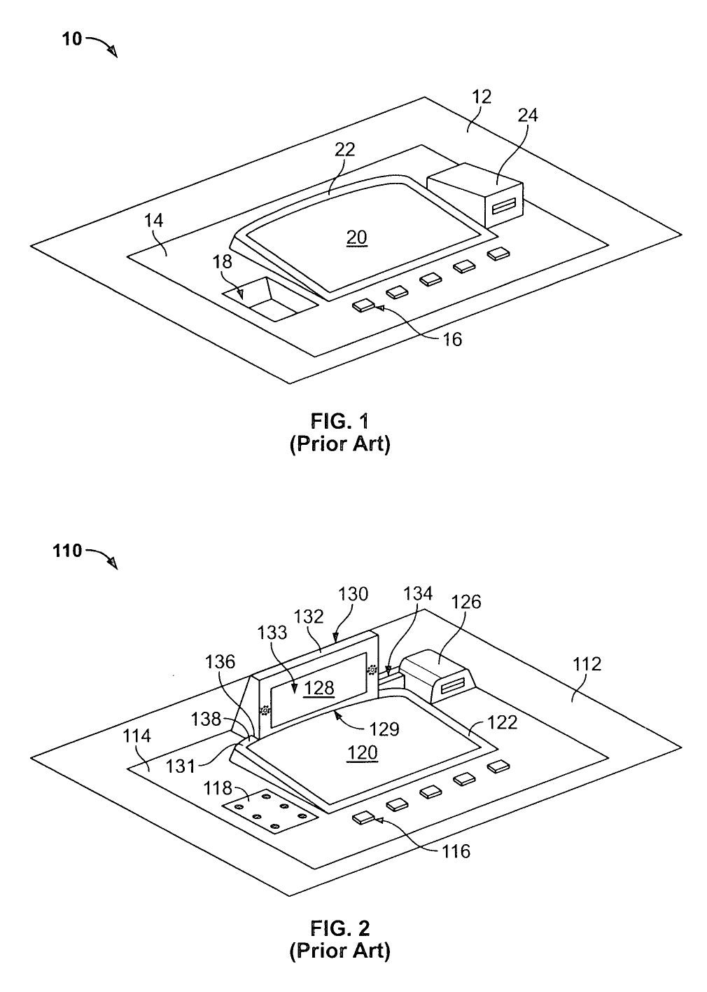

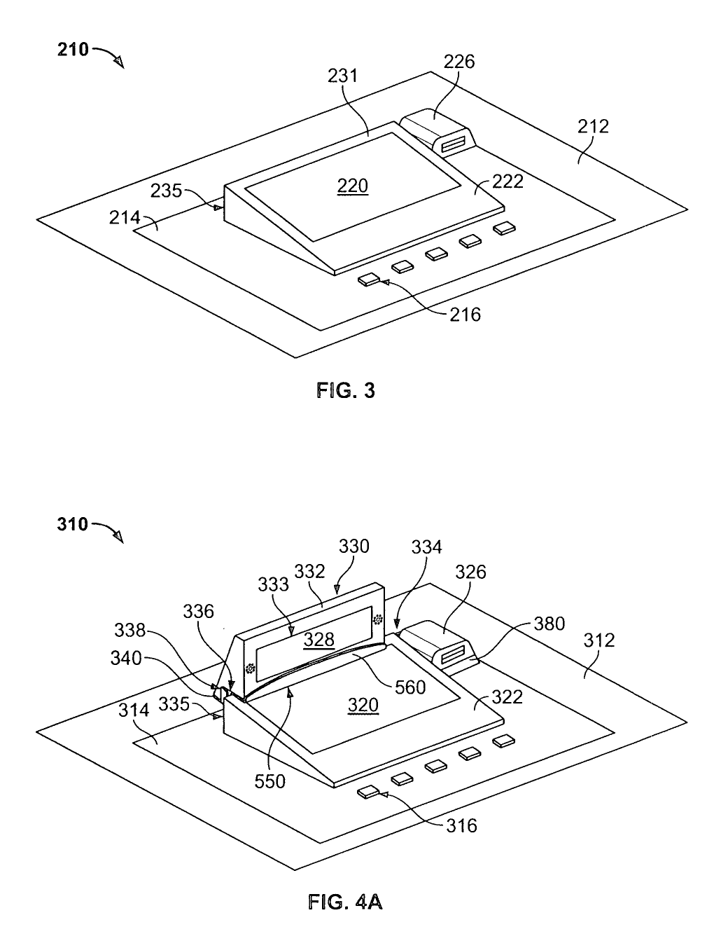

Auxiliary video display unit 330, in this embodiment, is configured to mount over a bezel on a CRT display, such as the auxiliary video display unit 130 shown and described with respect to FIG. 2. Auxiliary video display unit 330 may further include an associated card validator 326 associated with the auxiliary video display unit 330, as previously described. Auxiliary video display unit 330 includes a bottom region having a surface 336 configured to engage a top surface of a CRT display bezel, and a surface 338 configured to engage a rear side of a CRT display bezel.

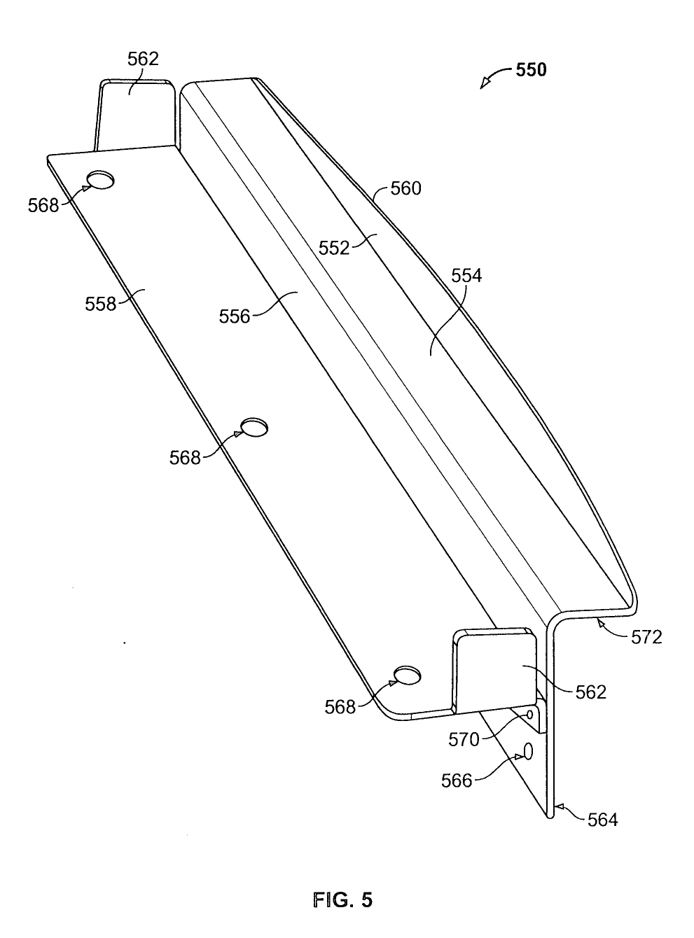

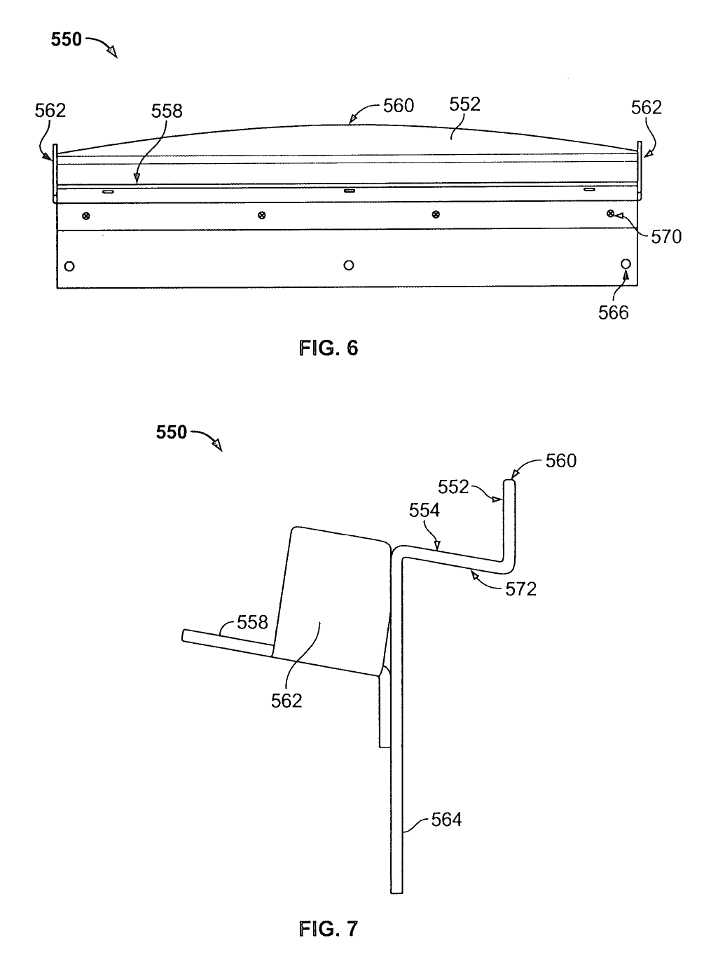

Auxiliary video display unit 330 is mounted onto adapter 550. As shown in FIGS. 4-7, adapter 550 is preferably configured to mount over flat panel display bezel 322 on bottom surfaces 564, 572, and to secure auxiliary video display unit 330 onto top surfaces 554, 556, and 558. In one embodiment, adapter 550 includes surface 554, which is configured to engage bottom surface 336 of auxiliary video display unit 330. Extension 552 may be provided at a front edge of surface 554 to cover over a space between surface 554 and bottom surface of auxiliary video display unit 330 resulting from the concave configuration of bottom surface of auxiliary video display unit 330. Extension 552 may be of any size and shape suitable for covering any open space between surface 554 and bottom surface of auxiliary video display unit 330, and in a preferred embodiment extension 552 has a convex top edge 560.

Adapter 550 may also include surface 556 that is configured to engage bottom surface 338 of auxiliary video display unit 330, that is configured to engage the rear side 334 of a CRT bezel. Adapter surface 558 is configured to engage bottom surface 340 of auxiliary video display unit 330. Adapter surface 558, when implemented over a CRT bezel, is in contact with plate 314. Surface 558 may further include holes 568 through which fasteners may be inserted into holes (not shown) in bottom surface 340 of auxiliary video display unit 330. Side walls 562 may be attached to the edges of either top surfaces 556 or 558 to cover any gap between bottom surface 336 of auxiliary video display unit 330 and adapter top surfaces 556, 558. Holes 566 may also be disposed through vertical member 564 through which fasteners may be inserted to attach to the rear side 335 of bezel 322.

Adapter 550 may be formed of one or more pieces of material, preferably sheet metal. In a preferred embodiment, adapter 550 may include two or more pieces that are fastened together in any suitable manner, including fasteners or spot welds. The configurations of the surfaces and walls may be formed by way of bending the sheet metal according to well-known practices. Adapter 55 may be alternately unitary and formed of sheet metal, cast iron, or injection molded plastic and the like.

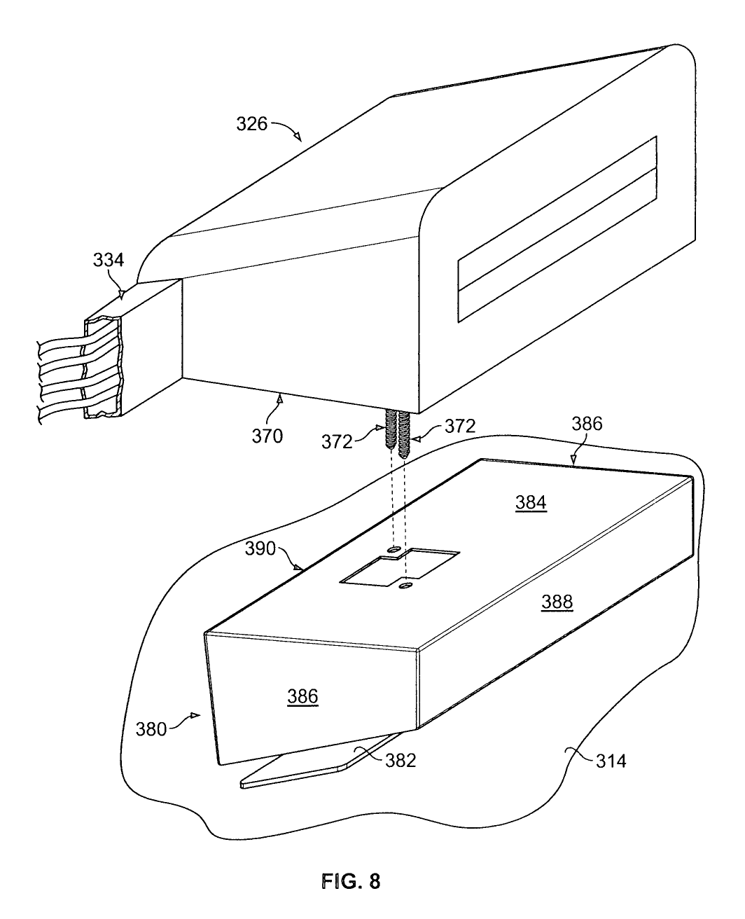

As previously described, auxiliary video display unit 330 may optionally include card validator 326 and conduit 334. When auxiliary video display unit 330 is installed at the height of a typical flat panel display bezel rear side 335, bottom surface 370 of card validator 326 and conduit 334 are spaced apart from plate 314. As shown in FIGS. 4 and 8, in an embodiment of the inventive support 380 is positioned on plate 314 and under card validator 326, and further adjacent flat panel display bezel 322. Flange 382 may also be included and positioned under bezel 322 to assist in securing support 380 to the plate 314. In other embodiments, support 380 may be directly attached to plate 314 by way of fastener or spot welds or the like. Card validator 326 may be attached to support 380 by way of screws 372 or the like. Support 380 may be formed of, for example, a single piece of sheet metal that is bent and spot welded together. Support 380 may further include top 384, sides 386, front 388 and back 390. According to another embodiment of the invention, the LCD of the auxiliary video display unit, such as auxiliary video display unit 328, may be replaced by signage for displaying information, advertising and the like. Other materials and fabrication methods may also be used without departing from the scope of the invention.

The above description of illustrated embodiments of the invention is not intended to be exhaustive or to limit the invention to the precise form disclosed. While specific embodiments of, and examples of, the invention are described in the foregoing for illustrative purposes, various equivalent modifications are possible within the scope of the invention, as those skilled in the relevant art will realize. Moreover, the various embodiments described above can be combined to provide further embodiments. Accordingly, the invention is not limited by the disclosure, but instead the scope of the invention is to be determined entirely by the following claims.

What is claimed is:

1. A gaming console configured for presenting a plurality of video displays to a user, comprising:
a bezel, the bezel being adapted to position and mount a flat panel video display, the bezel having a generally annular top surface with peripheral edges, the generally annular top surface having a rear portion, the bezel further including at least two sides and a back attached to peripheral edges of the bezel top surface; and
a support member attached to the rear portion of the bezel top side, the support member having a top surface being adapted to engage an auxiliary video display, the support member further including a bottom surface adapted to engage at least one of the rear portion of the bezel top side and the bezel back.

2. The gaming console of claim 1 further comprising an auxiliary video display mounted to the support member top side.

3. The gaming console of claim 1 further comprising signage mounted to the support member top side.

4. The gaming console of claim 2, wherein the auxiliary video display has a concave bottom surface adapted to mount over a convex surface, and wherein the auxiliary video display bottom surface and the support member top surface define a gap therebetween when the auxiliary video display is mounted on the support member top surface, and wherein the support member top surface has a front edge, further comprising:
a cover attached proximate the front edge of the support member top surface, the cover being adapted to extend over the gap between the auxiliary video display bottom surface and the support member top surface.

5. The gaming console of claim 2 wherein the gaming console is a bar-top or table-top console having a substantially horizontal mounting surface to which peripheral electronics and video displays may be mounted, and wherein the auxiliary video display has a housing and the auxiliary video display is elevated relative to the mounting surface, further comprising:
a card reader assembly attached to the auxiliary video display housing, the card reader extending laterally from the auxiliary video display housing, the card reader assembly including a bottom side, the card reader bottom side positioned at an elevation above the mounting surface; and
a support positioned below at least a portion of the card reader bottom side, the support extending between the at least a portion of the card reader bottom side and the mounting surface.

6. The gaming console of claim 2 wherein the gaming console is a bar-top or table-top console having a substantially horizontal mounting surface to which peripheral electronics and video displays may be mounted, further comprising peripheral electronics mounted to the mounting surface, wherein the peripheral electronics are configured to allow user interaction with a game implemented by the gaming console.

7. The gaming console of claim 2 further comprising:
a flat panel video display disposed within the bezel; and
a touch screen device operatively associated with the flat panel video display, wherein the touch screen device is configured to allow user interaction with a game implemented by the gaming console.

8. A support member for mounting an auxiliary video display, comprising:
a top surface adapted to engage and support a bottom surface of an auxiliary video display; and
a bottom surface adapted to engage at least one of a top surface and a back surface of a bezel.

9. The support member of claim 8 wherein the support member top surface is adapted to engage an auxiliary video display having a concave bottom surface, and wherein the support member has a front edge, further comprising:
a cover attached proximate the front edge of the support member top surface, the cover being adapted to extend over a gap between a concave auxiliary video display bottom surface and the support member top surface when an auxiliary video display having a concave bottom surface is mounted thereon.

10. The support member of claim 8 wherein the support member bottom surface is adapted to engage a bezel for mounting a flat panel display.

11. The support member of claim 8 wherein the support member bottom surface is adapted to engage at least one of a top surface and a back surface of a bezel for mounting a flat panel display.

12. A method of presenting a plurality of video displays to a user, comprising:
providing a bezel, the bezel being adapted to position and mount a flat panel video display, the bezel having a generally annular top surface with peripheral edges, the generally annular top surface having a rear portion, the bezel further including at least two sides and a back attached to peripheral edges of the bezel top surface; and
attaching a support member to the rear portion of the bezel top side, the support member having a top surface being adapted to engage an auxiliary video display configured to mount over a CRT display bezel, the support member further including a bottom surface adapted to engage at least one of the rear portion of the bezel top side and the bezel back.

13. The method of claim 12 further comprising:
providing an auxiliary video display; and
mounting the auxiliary video display to the support member top side.

14. The method of claim 13, wherein the auxiliary video display has a concave bottom surface adapted to mount over a convex surface, and wherein the auxiliary video display bottom surface and the support member top surface define a gap therebetween when the auxiliary video display is mounted on the support member top surface, and wherein the support member top surface has a front edge, further comprising:
attaching a cover proximate the front edge of the support member top surface, the cover being adapted to extend over the gap between the auxiliary video display bottom surface and the support member top surface.

15. The method of claim 13 wherein the gaming console is a bar-top or table-top console having a substantially horizontal mounting surface to which peripheral electronics and video displays may be mounted, and wherein the auxiliary video display has a housing and the auxiliary video display is elevated relative to the mounting surface, further comprising:
providing a card reader assembly attached to the auxiliary video display housing, the card reader extending laterally from the auxiliary video display housing, the card reader assembly including a bottom side, the card reader bottom side positioned at an elevation above the mounting surface;
providing a support positioned below at least a portion of the card reader bottom side, the support extending between the at least a portion of the card reader bottom side and the mounting surface; and
supporting the card reader assembly with the support.

16. The method of claim 13 wherein the gaming console is a bar-top or table-top console having a substantially horizontal mounting surface to which peripheral electronics and video displays may be mounted, further comprising mounting peripheral electronics to the mounting surface, wherein the peripheral electronics are configured to allow user interaction with a game implemented by the gaming console.

17. The method of claim 13 further comprising:
disposing a flat panel video display within the bezel; and
providing a touch screen device operatively associated with the flat panel video display, wherein the touch screen device is configured to allow user interaction with a game implemented by the gaming console.
